(19) United States
(12) Patent Application Publication
(10) Pub. No.: US 2016/0323529 A1
(43) Pub. Date: Nov. 3, 2016

(54) SIGNAL READOUT CIRCUIT, IMAGING APPARATUS, AND IMAGING SYSTEM

(71) Applicant: CANON KABUSHIKI KAISHA, Tokyo (JP)

(72) Inventor: Takanori Yamashita, Hachioji-shi (JP)

(21) Appl. No.: 15/135,409

(22) Filed: Apr. 21, 2016

(30) Foreign Application Priority Data
May 1, 2015 (JP) 2015-093882

(51) Int. Cl. H04N 5/378; H04N 5/357; H04N 5/3745

(52) U.S. Cl. CPC H04N 5/378; H04N 5/37452; H04N 5/37457; H04N 5/357

(57) ABSTRACT

Provided is a signal readout circuit, including: an input unit to which a first signal and a second signal are input; a first holding capacitor configured to hold the first signal input from the input unit; a second holding capacitor configured to hold the second signal input from the input unit; and an amplifier circuit including an input terminal and an output terminal and configured to be able to input a signal held in one of the first holding capacitor and the second holding capacitor to the input terminal, in which, in a period in which the first signal is input from the input unit to the first holding capacitor, the first signal is input to the input terminal of the amplifier circuit via the first holding capacitor.

### BACKGROUND OF THE INVENTION

1. Field of the Invention

The present invention relates to a signal readout circuit, an imaging apparatus, and an imaging system.

2. Description of the Related Art

In Japanese Patent Application Laid-Open No. H01-117481, there is described a signal readout circuit in which a noise component N and a sensor signal S including the noise component N are held in capacitors Ct1 and Ct2, respectively, and those signals are input to a base of a common buffer amplifier Q. In a reading method of the signal readout circuit, the capacitors Ct1 and Ct2 and the base of the buffer amplifier Q are reset in a period in which the noise component N and the sensor signal S are read out.

However, in order to reset the capacitors Ct1 and Ct2 and the base of the buffer amplifier Q, the signal readout circuit in Japanese Patent Application Laid-Open No. H01-117481 requires a transistor Qbc and a ground line for the reset. Thus, this increases the circuit scale of the signal readout circuit.

### SUMMARY OF THE INVENTION

According to one embodiment of the present invention, there is provided a signal readout circuit, including: an input unit to which a first signal and a second signal are input; a first holding capacitor configured to hold the first signal input from the input unit; a second holding capacitor configured to hold the second signal input from the input unit; and an amplifier circuit including an input terminal and an output terminal and configured to be able to input a signal held in one of the first holding capacitor and the second holding capacitor to the input terminal, in which, in a period in which the first signal is input from the input unit to the first holding capacitor, the first signal is input to the input terminal of the amplifier circuit via the first holding capacitor.

According to one embodiment of the present invention, there is provided an imaging apparatus, including: a signal readout circuit including: an input unit to which a first signal and a second signal are input; a first holding capacitor configured to hold the first signal input from the input unit; a second holding capacitor configured to hold the second signal input from the input unit; and an amplifier circuit including an input terminal and an output terminal and configured to be able to input a signal held in one of the first holding capacitor and the second holding capacitor to the input terminal, in a period in which the first signal is input from the input unit to the first holding capacitor, the first signal being input to the input terminal of the amplifier circuit via the first holding capacitor; and a pixel configured to output an image signal based on an amount of incident light and a noise signal corresponding to a noise component included in the image signal to the input unit of the signal readout circuit, in which one of the first signal and the second signal is the noise signal and another of the first signal and the second signal is the image signal.

According to one embodiment of the present invention, there is provided an imaging system, including: an imaging apparatus including: a signal readout circuit including: an input unit to which a first signal and a second signal are input; a first holding capacitor configured to hold the first signal input from the input unit; a second holding capacitor configured to hold the second signal input from the input unit; and an amplifier circuit including an input terminal and an output terminal and configured to be able to input a signal held in one of the first holding capacitor and the second holding capacitor to the input terminal, in a period in which the first signal is input from the input unit to the first holding capacitor, the first signal being input to the input terminal of the amplifier circuit via the first holding capacitor; and a pixel configured to output an image signal based on an amount of incident light and a noise signal corresponding to a noise component included in the image signal to the input unit of the signal readout circuit, one of the first signal and the second signal being the noise signal and another of the first signal and the second signal being the image signal; and a signal processing unit configured to generate an image using a signal output from the imaging apparatus.

Further features of the present invention will become apparent from the following description of exemplary embodiments with reference to the attached drawings.

### BRIEF DESCRIPTION OF THE DRAWINGS

FIG. 1 is a block diagram of an imaging apparatus according to a first embodiment of the present invention.

FIG. 2 is a circuit diagram of a signal readout circuit according to the first embodiment of the present invention.

FIG. 3 is a timing chart of the signal readout circuit according to the first embodiment of the present invention.

FIG. 4 is a timing chart of a signal readout circuit according to a second embodiment of the present invention.

FIG. 5 is a block diagram of an imaging system according to a third embodiment of the present invention.

### DESCRIPTION OF THE EMBODIMENTS

Preferred embodiments of the present invention will now be described in detail in accordance with the accompanying drawings.

### First Embodiment

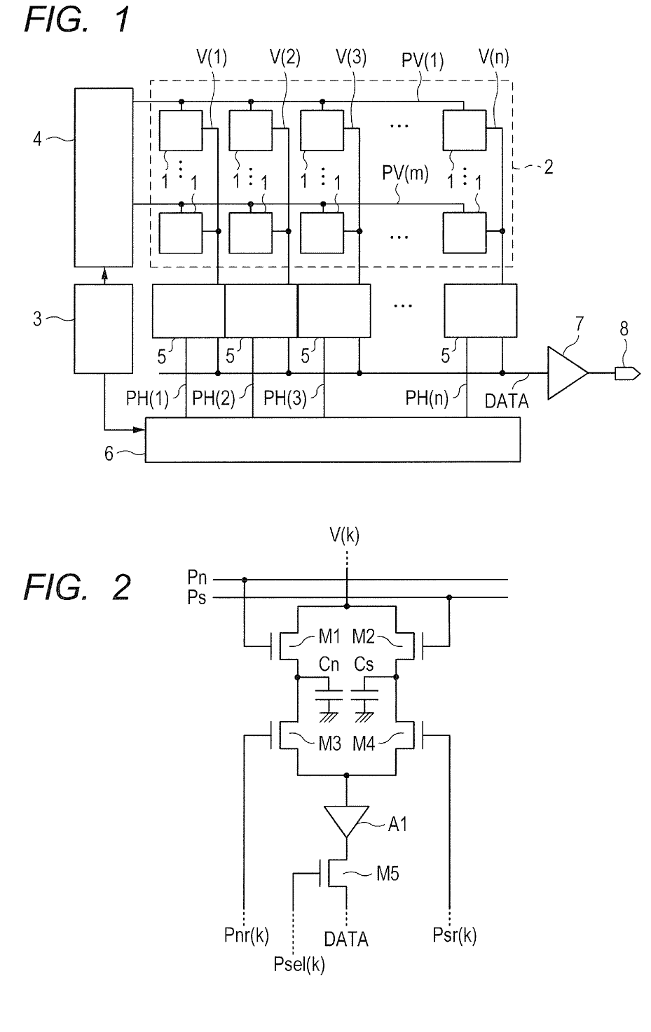

FIG. 1 is a block diagram of an imaging apparatus according to a first embodiment of the present invention. The imaging apparatus includes a pixel region 2, a timing generator 3, a vertical drive circuit 4, signal readout circuits 5, a horizontal drive circuit 6, and an output amplifier circuit 7. A plurality of pixels 1 are arranged in a matrix form of m rows×n columns (m and n are natural numbers) in the pixel region 2. Each of the pixels 1 has a photoelectric conversion element such as a photodiode configured to photoelectrically convert incident light.

The plurality of pixels 1 are controlled by control signals that are input from the vertical drive circuit 4 via row control signal lines PV(1), . . . PV(m) that are formed for the respective rows. Note that, indices in parentheses in the row control signal lines PV(1), . . . PV(m) denote row numbers. Each of the pixels 1 generates, as voltage signals, an image signal S based on an amount of incident light and a noise signal N corresponding to a noise component included in the image signal S. In other words, each of the pixels 1 outputs a first signal and a second signal, any one of the first signal and the second signal being the noise signal N and another being the image signal S. The generated image signals and noise signals are output from the respective pixels 1 to vertical readout lines V(1), . . . V(n) that are formed for the respective columns. Note that, indices in parentheses in the vertical readout lines V(1), . . . V(n) denote column numbers.

The timing generator 3 supplies control signals for controlling the vertical drive circuit 4, the horizontal drive circuit 6, and other circuit blocks (not shown) at predetermined operation timings.

The vertical readout lines V(1), . . . V(n) are connected to the signal readout circuits 5 formed for the respective columns, respectively. Output terminals of the signal readout circuits 5 in the respective columns are connected in common to a common signal line DATA. In this embodiment, the image signals S and the noise signals N that are output from the signal readout circuits 5 to the common signal line DATA are analog voltage signals. The signal readout circuits 5 for the respective columns are controlled by control signals that are input from the horizontal drive circuit 6 via corresponding column control signal lines PH, respectively, among column control signal lines PH(1), . . . PH(n). Each of the column control signal lines PH(1), . . . PH(n) is illustrated as a single line, but is actually formed of a plurality of signal lines and transmits a plurality of control signals. Note that, indices in parentheses in the column control signal lines PH(1), . . . PH(n) denote column numbers.

Note that, it is not essential that signals that are output from the signal readout circuits 5 to the common signal line DATA be analog signals, and, for example, a configuration may also be employed in which an A/D conversion circuit is added and an analog signal is, after being converted to a digital signal, output to the common signal line DATA.

A signal that is output to the common signal line DATA is input to the output amplifier circuit 7. The output amplifier circuit 7 performs processing such as amplification of the signal that is input, and outputs the processed signal to the outside of the imaging apparatus via an external terminal 8.

For example, the output amplifier circuit 7 may perform processing of subtracting the noise component of the noise signal N from the image signal S. In this case, the output amplifier circuit 7 has a unit configured to clamp an input signal. When the noise signal N is output to the common signal line DATA, the output amplifier circuit 7 outputs a clamp voltage VCL. When the image signal S is output to the common signal line DATA, the output amplifier circuit 7 outputs a voltage (VCL-ΔVS) with the clamp voltage VCL as a reference, where ΔVS is a difference in voltage between the noise signal N and the image signal S. In this way, through obtainment of the difference between the noise signal N and the image signal S, a signal after the noise component is subtracted therefrom is output.

Note that, there may be a plurality of common signal lines DATA, a plurality of output amplifier circuits 7, and a plurality of external terminals 8. In this case, each of the signal readout circuits 5 is connected to any one of the plurality of common signal lines DATA, and signals can be output in parallel from the plurality of signal readout circuits 5.

Next, the signal readout circuits 5 are described in detail. FIG. 2 is a circuit diagram of the signal readout circuit 5 according to the first embodiment of the present invention. In the description below, the signal readout circuit 5 is formed in a k-th column (k is a natural number), but other columns have a similar configuration.

The signal readout circuit 5 includes switch transistors M1, M2, M3, M4, and M5, holding capacitors Cn and Cs, and an amplifier circuit A1. The switch transistors M1, M2, M3, M4, and M5 are controlled by control signals Pn, Ps, Pnr(k), Psr(k), and Psel(k), respectively. The control signals Pn and Ps are signals given in common to the signal readout circuits 5 of the plurality of columns. The control signals Pnr(k), Psel(k), and Psr(k) are signals that are given at timings different among the columns, and indices in parentheses therein denote column numbers. The switch transistors M1, M2, M3, M4, and M5 can be, for example, MOSFETs. The control signals Pnr(k), Psel(k), and Psr(k) are input from the horizontal drive circuit 6 via the column control signal line PH(k). The control signals Pn and Ps are input from a control circuit (not illustrated). The amplifier circuit A1 can be, for example, a source follower circuit. Other examples of the amplifier circuit A1 include a differential amplifier, a fully differential amplifier, and a common source amplifier circuit. For example, when a differential amplifier including a feedback capacitor is the amplifier circuit A1, one node of the feedback capacitor is connected to an output terminal of the differential amplifier, and another node thereof is connected to an input terminal of the differential amplifier. In a configuration of this embodiment, a reset path that short-circuits the one node and the another node of the feedback capacitor can be omitted.

The vertical readout line V(k) serving as an input unit configured to input a signal to the signal readout circuit 5 is connected to one terminal of the switch transistor M1 and one terminal of the switch transistor M2. Another terminal of the switch transistor M1 is connected to one terminal of the holding capacitor Cn and one terminal of the switch transistor M3. Another terminal of the switch transistor M2 is connected to one terminal of the holding capacitor Cs and one terminal of the switch transistor M4. Another terminal of the holding capacitor Cn and another terminal of the holding capacitor Cs are grounded. Another terminal of the switch transistor M3 and another terminal of the switch transistor M4 are connected to an input terminal of the amplifier circuit A1. An output terminal of the amplifier circuit A1 is connected to one terminal of the switch transistor M5. Another terminal of the switch transistor M5 is connected to the common signal line DATA.

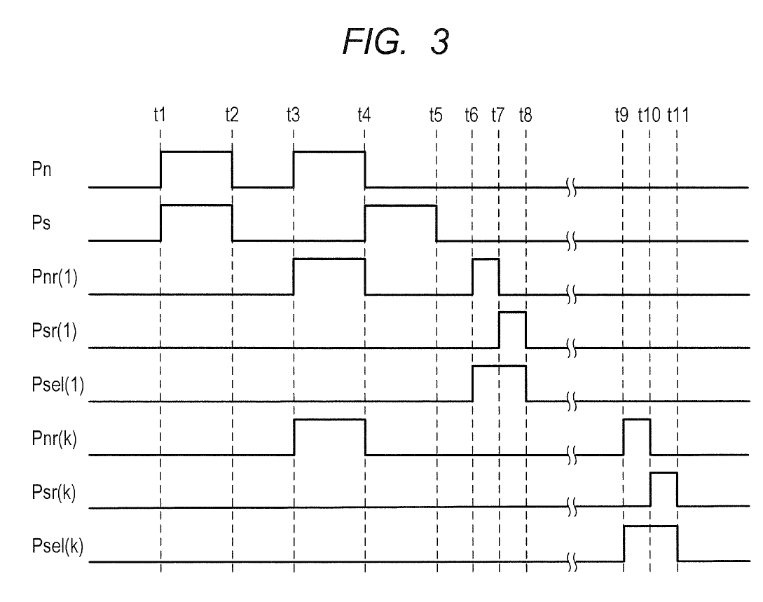

FIG. 3 is a timing chart in the signal readout circuit according to the first embodiment of the present invention. Operation of the signal readout circuit in the first column and the signal readout circuit in the k-th column is described below. Note that, when a control signal is at a high level (H level), a switch transistor corresponding thereto is ON (in a conducting state), and, when a control signal is at a low level (L level), a switch transistor corresponding thereto is OFF (in a non-conducting state).

In a period from a time t1 to a time t4, the noise signals N are output from the pixels 1 in the respective columns to the vertical readout lines V(1), . . . V(n). In a period from the time t4 to a time t5, the image signals S are output.

At the time t1, the control signals Pn and Ps are changed from the L level to the H level. This changes the switch transistors M1 and M2 from the OFF state to the ON state. Specifically, the noise signal N is input to both the holding capacitors Cn and Cs.

At a time t2, the control signals Pn and Ps are changed from the H level to the L level. This changes the switch transistors M1 and M2 from the ON state to the OFF state. Specifically, the noise signal N is held in both the holding capacitors Cn and Cs.

At a time t3, the control signals Pn, Pnr(1), and Pnr(k) are changed from the L level to the H level. Note that, the same applies to control signals Pnr(2), . . . Pnr(k−1), Pnr(k+1), . . . Pnr(n) (not illustrated). This changes the switch transistors M1 and M3 in each of the columns from the OFF state to the ON state. In other words, the noise signal N is applied to both the holding capacitor Cn and the input terminal of the amplifier circuit A1 in each of the signal readout circuits 5 in the respective columns. The input terminal of the amplifier circuit A1 has a parasitic capacitance Cf due to wiring or the like, and the noise signal N is input to the parasitic capacitance Cf of the input terminal of the amplifier circuit A1. Note that, the holding capacitors Cn and Cs have capacitance values that are larger than that of the parasitic capacitance Cf.

At the time t4, the control signals Pn, Pnr(1), and Pnr(k) are changed from the H level to the L level, and the control signal Ps is changed from the L level to the H level. Note that, the same applies to the control signals Pnr(2), . . . Pnr(k−1), Pnr(k+1), . . . Pnr(n) (not illustrated). This changes the switch transistors M1 and M3 in each of the columns from the ON state to the OFF state, and changes the switch transistor M2 from the OFF state to the ON state. In other words, the holding capacitor Cn and the parasitic capacitance Cf of the input terminal of the amplifier circuit A1 in each of the columns are in a state of holding the noise signal N, and the image signal S is input to the holding capacitors Cs in the respective columns from the vertical readout lines V(1), . . . V(n).

At the time t5, the control signal Ps is changed from the H level to the L level. This changes the switch transistor M2 from the ON state to the OFF state. Specifically, the image signal S is held in the holding capacitor Cs.

After that, in a period starting at a time t6, operation is performed to read, in sequence, the noise signal N and the image signal S that are held in the holding capacitors Cn and Cs, respectively, in the signal readout circuit 5 in each of the columns out to the common signal line DATA via the amplifier circuit A1.

At the time t6, the control signals Pnr(1) and Psel(1) for controlling the signal readout circuit 5 in the first column change from the L level to the H level. This changes the switch transistors M3 and M5 from the OFF state to the ON state. In other words, the noise signal N held in the holding capacitor Cn is output to the common signal line DATA via the amplifier circuit A1.

At a time t7, the control signal Pnr(1) changes from the H level to the L level, and the control signal Psr(1) changes from the L level to the H level. This changes the switch transistor M3 from the ON state to the OFF state, and changes the switch transistor M4 from the OFF state to the ON state. In other words, the image signal S held in the holding capacitor Cs is output to the common signal line DATA via the amplifier circuit A1.

At a time t8, the control signals Psr(1) and Psel(1) change from the H level to the L level. This changes the switch transistors M4 and M5 from the ON state to the OFF state. In other words, in the period from the time t6 to the time t8, signal readout is performed from the signal readout circuit in the first column to the common signal line DATA.

In a period starting at the time t8, signal readout from the signal readout circuits in the second and subsequent columns starts in sequence similarly to the circuit operation of the signal readout circuit in the first column. In a period from a time t9 to a time t11, signal readout is performed from the signal readout circuit in the k-th column to the common signal line DATA. In a period from the time t9 to a time t10, the noise signal N held in the holding capacitor Cn is read out to the common signal line DATA via the amplifier circuit A1. In a period from the time t10 to the time t11, the image signal S held in the holding capacitor Cs is read out to the common signal line DATA via the amplifier circuit A1. Signal readout is similarly performed with regard to the second to the (k−1)th columns and the (k+1)th to the n-th columns (not illustrated).

In this embodiment, in the period from the time t3 to the time t4, in parallel with the operation of inputting the noise signal N to the holding capacitor Cn, the noise signal N is input to the parasitic capacitance Cf of the input terminal of the amplifier circuit A1 via the holding capacitor Cn. In other words, the voltage at the input terminal of the amplifier circuit A1 is reset by the noise signal N.

Such a configuration enables, for example, in the signal readout circuits 5 in the first column, in the period from the time t6 to the time t7, readout of the noise signal N with high accuracy without increasing the circuit scale.

Now, a case in which the input terminal of the amplifier circuit A1 is not reset by the noise signal N is described as a comparative example to describe in further detail an effect of this embodiment.

In this comparative example, in the period from the time t3 to the time t4, the control of changing the control signals Pn and Pnr(1) to Pnr(n) to the H level is not executed. In such a case, the voltage at the input terminal of the amplifier circuit A1 immediately before the time t6 is not constant. For example, immediately before the time t6, the parasitic capacitance Cf of the input terminal of the amplifier circuit A1 holds the image signal S as a readout signal of the previous row, and the noise signal N is held in the holding capacitor Cn.

In the period from the time t6 to the time t7, the switch transistor M3 is changed from the OFF state to the ON state. In this case, the voltage at the input terminal of the amplifier circuit A1 is determined by a capacitance ratio between the holding capacitor Cn and the parasitic capacitance Cf and the voltages held in the holding capacitor Cn and in the parasitic capacitance Cf immediately before the time t6. Specifically, in this comparative example, under the influence of the image signal S held in the parasitic capacitance Cf of the input terminal of the amplifier circuit A1 immediately before the time t6, the voltage at the input terminal of the amplifier circuit A1 fluctuates. Therefore, the accuracy of the noise signal N that is output from the amplifier circuit A1 may deteriorate.

On the other hand, in this embodiment, before the period from the time t6 to the time t7 when the noise signal N is read out, the noise signal N is held in the parasitic capacitance Cf of the input terminal of the amplifier circuit A1. Therefore, in this embodiment, in the period from the time t6 to the time t7, voltage fluctuations when the switch transistor M3 is changed from the OFF state to the ON state are reduced. Therefore, the noise signal N can be read out with higher accuracy. Further, realization of the configuration of this embodiment does not require addition of an element to the comparative example, and thus, the circuit scale of the signal readout circuit 5 is not increased. For the reasons described above, in this embodiment, a signal readout circuit that realizes highly accurate readout with a reduced circuit scale is provided.

Further, in this embodiment, the input terminal of the amplifier circuit A1 is reset in parallel with the operation of writing the noise signal N in the holding capacitor Cn in the period from the time t3 to the time t4. This eliminates the necessity of securing a period in which the input terminal of the amplifier circuit A1 is reset separately from a period in which the noise signal N is held in the holding capacitor Cn, which is suitable for increasing a readout speed.

A readout method according to the present invention is not limited to the one according to this embodiment, and another operation method may also be employed. It is enough that another operation method is a driving method involving resetting, in parallel with the operation of writing a signal in the holding capacitor Cn or the holding capacitor Cs of the signal readout circuit 5, the input terminal of the amplifier circuit A1 by the same signal.

Note that, the signal that resets the input terminal of the amplifier circuit A1 may be any one of the noise signal N and the image signal S. Specifically, as a variation of the embodiment described above, instead of the noise signal N, the image signal S may reset the input terminal of the amplifier circuit A1. In this case, by reversing the order of the readout of the noise signal N and the readout of the image signal S in the period starting at the time t6 and performing the readout of the image signal S first, a similar effect is obtained.

Further, in this embodiment, in the period from the time t3 to the time t4, both the control signal Pn and the control signals Pnr(1), . . . , Pnr(n) are simultaneously changed to the H level, but it is not essential that the two be always at the H level in the period. In this embodiment, it is enough that the noise signal N is input to the input terminal of the amplifier circuit A1 and the parasitic capacitance Cf is charged by the voltage of the noise signal N, and thus, it is enough that a period in which both the control signal Pn and the control signals Pnr(1), . . . Pnr(n) are at the H level exists for a while.

### Second Embodiment

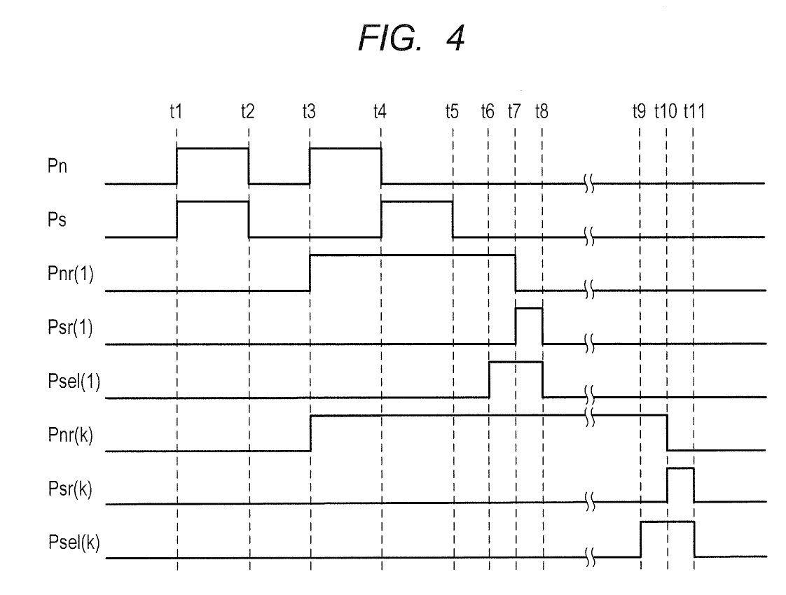

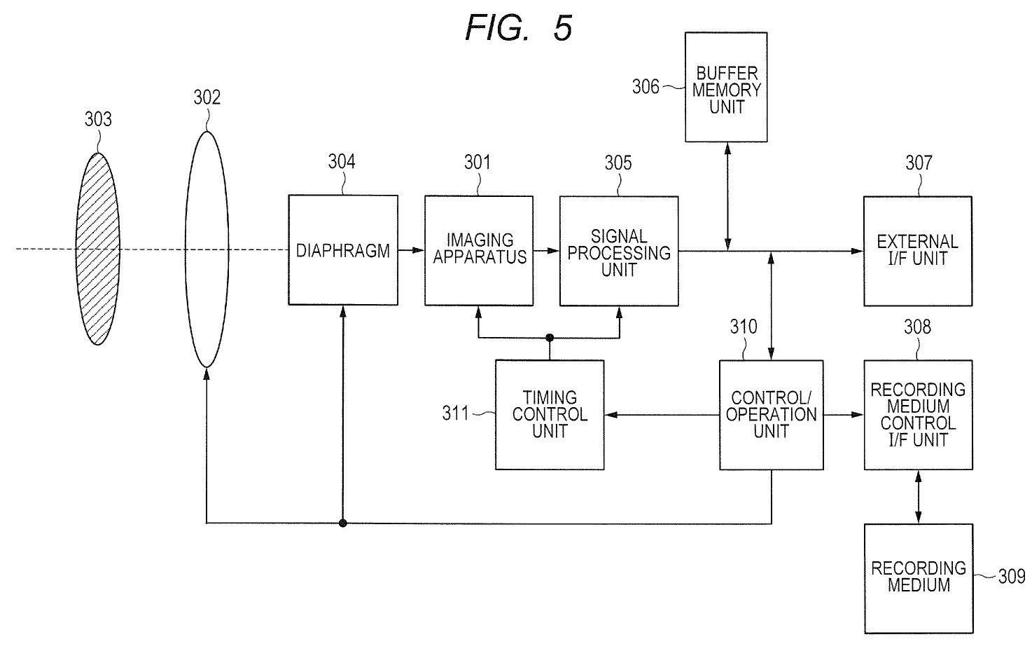

FIG. 4 is a timing chart in the signal readout circuit according to the second embodiment of the present invention. The circuit configuration of this embodiment is similar to that of the first embodiment illustrated in FIG. 1 and FIG. 2, and thus, description thereof is omitted. A different point from the first embodiment is described below with reference to the timing chart of FIG. 4.

This embodiment is different from the first embodiment in that the control signals Pnr(1), . . . Pnr(n) are maintained at the H level in a period from the time t3 at which the noise signal N is input to the holding capacitor Cn to a time at which the noise signal N is read out to the common signal line DATA. Operation timings of the control signals Pn, Ps, Psr(1), . . . Pnr(n), Psel(1), . . . Psel(n) are the same as those of the first embodiment.

Specifically, in this embodiment, through maintaining the switch transistors M3 of the signal readout circuits 5 in the ON state, the holding capacitor Cn is kept connected to the input terminal of the amplifier circuit A1 in a period until the noise signal N is read out.

The parasitic capacitance Cf of the input terminal of the amplifier circuit A1 has a capacitance value that is smaller than the capacitance values of the holding capacitors Cn and Cs. Therefore, the voltage of the noise signal N held in the parasitic capacitance Cf is relatively liable to be fluctuated by noise from the outside. On the other hand, in this embodiment, the input terminal of the amplifier circuit A1 is connected to the holding capacitor Cn, and the noise signal N is held in a capacitor having a sufficiently large capacitance than that of the parasitic capacitance Cf, and thus, the voltage is less liable to be affected by noise. Therefore, in this embodiment, the noise signal N can be read out from the signal readout circuits 5 to the common signal line DATA with higher accuracy.

In this embodiment, in the period from the time t3 to the time at which the noise signal N is read out to the common signal line DATA, the control signals Pnr(1), . . . Pnr(n) are at the H level. However, the control signals Pnr(1), . . . Pnr(n) may be at the H level from a time earlier than the time t3. For example, the control signals Pnr(1), . . . Pnr(n) may be at the H level from the time t1.

### Third Embodiment

The imaging apparatus of the first and second embodiments described above are applicable to various imaging systems. Examples of the imaging systems include digital still cameras, digital camcorders, and monitoring cameras. FIG. 5 is a block diagram of an imaging system in which the imaging apparatus of any one of the embodiments described above is applied to a digital still camera as an example of an imaging system according to a third embodiment of the present invention.

The imaging system illustrated in FIG. 5 as an example includes an imaging apparatus 301, a barrier 303 for the protection of a lens 302, the lens 302, which forms an optical image of an object on the imaging apparatus 301, and a diaphragm 304, which makes the amount of light passed through the lens 302 variable. The lens 302 and the diaphragm 304 form an optical system configured to guide light to the imaging apparatus 301. The imaging apparatus 301 is the imaging apparatus of any one of the embodiments described above.

The imaging system illustrated in FIG. 5 as an example also includes a signal processing unit 305 configured to process a signal output from the imaging apparatus 301. The signal processing unit 305 generates an image based on a signal output by the imaging apparatus 301. Specifically, the signal processing unit 305 outputs image data after executing various corrections, compression, and other types of processing if necessary. The signal processing unit 305 performs focus detection as well, with the use of a signal output by the imaging apparatus 301.

The imaging system illustrated in FIG. 5 as an example further includes a buffer memory unit 306 in which image data is stored temporarily, and an external interface unit (external I/F unit) 307 through which communication to and from an external computer or the like is held. Other components of the imaging system include a recording medium 309 such as a semiconductor memory where imaging data is recorded or read out, and a recording medium control interface unit (recording medium control I/F unit) 308 with which the recording or readout of the recording medium 309 is executed. The recording medium 309 may be built in the imaging system or may be removable from the imaging system.

Still other components of the imaging system include a control/operation unit 310 configured to perform various calculations and the overall control of the digital still camera, and a timing control unit 311 configured to output various timing signals to the imaging apparatus 301 and the signal processing unit 305, and control operation timings of those components. The timing signals and other signals may be input from the outside, and it is sufficient if the imaging system includes at least the imaging apparatus 301 and the signal processing unit 305 configured to process a signal output from the imaging apparatus 301.

The imaging system of this embodiment is thus capable of performing imaging operation by applying the imaging apparatus 301.

The imaging system of the third embodiment is an example of imaging systems to which the imaging apparatus of the present invention can be applied, and imaging systems to which the imaging apparatus of the present invention can be applied are not limited to the configuration illustrated in FIG. 5.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-093882, filed May 1, 2015, which is hereby incorporated by reference herein in its entirety.

What is claimed is:

1. A signal readout circuit, comprising:
an input unit to which a first signal and a second signal are input;
a first holding capacitor configured to hold the first signal input from the input unit;
a second holding capacitor configured to hold the second signal input from the input unit; and
an amplifier circuit comprising an input terminal and an output terminal and configured to be able to input a signal held in one of the first holding capacitor and the second holding capacitor to the input terminal,
wherein, in a period in which the first signal is input from the input unit to the first holding capacitor, the first signal is input to the input terminal of the amplifier circuit via the first holding capacitor.

2. The signal readout circuit according to claim 1, wherein one of the first signal and the second signal comprises a signal corresponding to a noise component included in another of the first signal and the second signal.

3. The signal readout circuit according to claim 2, wherein the first signal comprises a signal corresponding to a noise component included in the second signal.

4. The signal readout circuit according to claim 1, wherein the first signal is kept being input from the input unit to the input terminal of the amplifier circuit in a period from a time at which the first signal is input from the input unit to the first holding capacitor to a time at which the first signal held in the first holding capacitor is read out from the amplifier circuit.

5. The signal readout circuit according to claim 4, wherein a parasitic capacitance formed at the input terminal of the amplifier circuit has a capacitance value that is smaller than a capacitance value of the first holding capacitor.

6. The signal readout circuit according to claim 1, wherein the first signal held in the first holding capacitor is read out in a period after the first signal is input to the input terminal of the amplifier circuit and before the second signal held in the second holding capacitor is read out.

7. The signal readout circuit according to claim 1, further comprising:
a first switch arranged between the input unit and the first holding capacitor; and
a second switch arranged between the first holding capacitor and the input terminal of the amplifier circuit,
wherein both the first switch and the second switch are in a conducting state in a period in which the first signal is input to the input unit.

8. An imaging apparatus, comprising:
a signal readout circuit comprising:
an input unit to which a first signal and a second signal are input;
a first holding capacitor configured to hold the first signal input from the input unit;
a second holding capacitor configured to hold the second signal input from the input unit; and
an amplifier circuit comprising an input terminal and an output terminal and configured to be able to input a signal held in one of the first holding capacitor and the second holding capacitor to the input terminal,
wherein, in a period in which the first signal is input from the input unit to the first holding capacitor, the first signal is input to the input terminal of the amplifier circuit via the first holding capacitor; and
a pixel configured to output an image signal based on an amount of incident light and a noise signal corresponding to a noise component included in the image signal to the input unit of the signal readout circuit,
wherein one of the first signal and the second signal comprises the noise signal and another of the first signal and the second signal comprises the image signal.

9. The imaging apparatus according to claim 8, wherein the first signal comprises a signal corresponding to a noise component included in the second signal.

10. The imaging apparatus according to claim 8, wherein the first signal is kept being input from the input unit to the input terminal of the amplifier circuit in a period from a time at which the first signal is input from the input unit to the first holding capacitor to a time at which the first signal held in the first holding capacitor is read out from the amplifier circuit.

11. The imaging apparatus according to claim 10, wherein a parasitic capacitance formed at the input terminal of the amplifier circuit has a capacitance value that is smaller than a capacitance value of the first holding capacitor.

12. The imaging apparatus according to claim 8, wherein the first signal held in the first holding capacitor is read out in a period after the first signal is input to the input terminal of the amplifier circuit and before the second signal held in the second holding capacitor is read out.

13. The imaging apparatus according to claim 8, further comprising:
a first switch arranged between the input unit and the first holding capacitor; and
a second switch arranged between the first holding capacitor and the input terminal of the amplifier circuit,
wherein both the first switch and the second switch are in a conducting state in a period in which the first signal is input to the input unit.

14. An imaging system, comprising:
an imaging apparatus comprising:
a signal readout circuit comprising:
an input unit to which a first signal and a second signal are input;
a first holding capacitor configured to hold the first signal input from the input unit;
a second holding capacitor configured to hold the second signal input from the input unit; and
an amplifier circuit comprising an input terminal and an output terminal and configured to be able to input a signal held in one of the first holding capacitor and the second holding capacitor to the input terminal,
wherein, in a period in which the first signal is input from the input unit to the first holding capacitor, the first signal is input to the input terminal of the amplifier circuit via the first holding capacitor; and
a pixel configured to output an image signal based on an amount of incident light and a noise signal corresponding to a noise component included in the image signal to the input unit of the signal readout circuit,
wherein one of the first signal and the second signal comprising the noise signal and another of the first signal and the second signal comprises the image signal; and
a signal processing unit configured to generate an image using a signal output from the imaging apparatus.

15. The imaging system according to claim 14, wherein the first signal comprises a signal corresponding to a noise component included in the second signal.

16. The imaging system according to claim 14, wherein the first signal is kept being input from the input unit to the input terminal of the amplifier circuit in a period from a time at which the first signal is input from the input unit to the first holding capacitor to a time at which the first signal held in the first holding capacitor is read out from the amplifier circuit.

17. The imaging system according to claim 16, wherein a parasitic capacitance formed at the input terminal of the amplifier circuit has a capacitance value that is smaller than a capacitance value of the first holding capacitor.

18. The imaging system according to claim 14, wherein the first signal held in the first holding capacitor is read out in a period after the first signal is input to the input terminal of the amplifier circuit and before the second signal held in the second holding capacitor is read out.

19. The imaging system according to claim 14, further comprising:
a first switch arranged between the input unit and the first holding capacitor; and
a second switch arranged between the first holding capacitor and the input terminal of the amplifier circuit,
wherein both the first switch and the second switch are in a conducting state in a period in which the first signal is input to the input unit.
